(19) United States
(12) Patent Application Publication
(10) Pub. No.: US 2012/0105674 A1
(43) Pub. Date: May 3, 2012

(54) IMAGE PRODUCING APPARATUS

(75) Inventor: Ryo Sakaji, Kyotanabe-shi (JP)

(73) Assignee: SANYO ELECTRIC CO., LTD., Osaka (JP)

(21) Appl. No.: 13/284,515

(22) Filed: Oct. 28, 2011

(30) Foreign Application Priority Data
Oct. 28, 2010 (JP) 2010-242772

(51) Int. Cl. H04N 5/235

(52) U.S. Cl. 348/229.1; 348/E05.037

(57) ABSTRACT

An image producing apparatus according to the present invention includes an image display device for displaying a frame image generated by photographing, a touch panel provided to cover the image display device, an automatic exposing unit for adjusting an exposure condition by setting, as a target, an automatic exposed area which is set on the screen, and an image recording unit for recording the frame image in response to a user manipulation, and an area setting unit for setting a plurality of automatic exposed areas on the screen in response to a manipulation of the touch panel, wherein the automatic exposing unit adjusts the exposure condition by setting, as a target, the plurality of automatic exposed areas which are set.

The present application claims priority to Japanese Patent Application No. 2010-242772, which is incorporated herein by reference.

### BACKGROUND OF THE INVENTION

1. Field of the Invention

The present invention relates to an image producing apparatus such as a digital camera and more particularly to an image producing apparatus capable of photographing a still image by using an automatic exposing function (an AE function).

2. Description of the Related Art

In conventional image producing apparatuses of this type, it is proposed to automatically adjust an exposure condition and a focus to an object in an area specified by a user by setting the area as a target in a still image photographing mode.

In an image producing apparatus having an AE function according to the conventional art, it is possible to automatically adjust an exposure condition to a specific one of people by specifying an area (an AE area) including the person in a state in which the people are displayed on a through-the-lens image, for example. However, if the exposure condition is to be also adjusted to a person at a position placed apart from the person, it is necessary to enlarge the AE area fully over a screen in such a manner that images of the two people are included in the AE area. For this reason, an object which does not require the adjustment of the exposure condition or is inappropriate to the adjustment of the exposure condition is also included in the AE area. As a result, there is a problem in that photographing cannot be carried out on a desirable exposure condition.

### SUMMARY OF THE INVENTION

An image producing apparatus according to the present invention includes an image display device for displaying a frame image (a through-the-lens image) generated sequentially by photographing, a touch panel provided to cover a screen of the image display device, an automatic exposing unit for automatically adjusting an exposure condition by setting, as a target, an automatic exposed area which is set on the screen, an image recording unit for recording the frame image in response to a user manipulation, and an area setting unit for setting a plurality of automatic exposed areas on the screen in response to a manipulation of the touch panel, wherein the automatic exposing unit adjusts the exposure condition by setting, as a target, the plurality of automatic exposed areas which are set by the area setting unit.

### BRIEF DESCRIPTION OF THE DRAWINGS

FIG. 1 is a block diagram showing an electrical configulation of a digital camera according to an embodiment of the present invention;

FIG. 2 is a flowchart representing a first part of a control procedure in an automatic exposure photographing mode;

FIG. 3 is a flowchart representing a second part of the control procedure in the automatic exposure photographing mode;

FIG. 4 is a view illustrating an example of an image display of a first operation scene in the automatic exposure photographing mode;

FIG. 5 is a view illustrating an example of an image display of a second operation scene in the automatic exposure photographing mode;

FIG. 6 is a view illustrating an example of an image display of a third operation scene in the automatic exposure photographing mode;

FIG. 7 is a view illustrating an example of an image display of a fourth operation scene in the automatic exposure photographing mode;

FIG. 8 is a view illustrating an example of an image display of a fifth operation scene in the automatic exposure photographing mode;

FIG. 9 is a view illustrating an example of an image display of a sixth operation scene in the automatic exposure photographing mode; and

FIG. 10 is a view illustrating an example of an image display of a seventh operation scene in the automatic exposure photographing mode.

### DETAILED DESCRIPTION OF THE PREFERRED EMBODIMENT

An embodiment of a digital camera according to the present invention will be specifically described below with reference to the drawings.

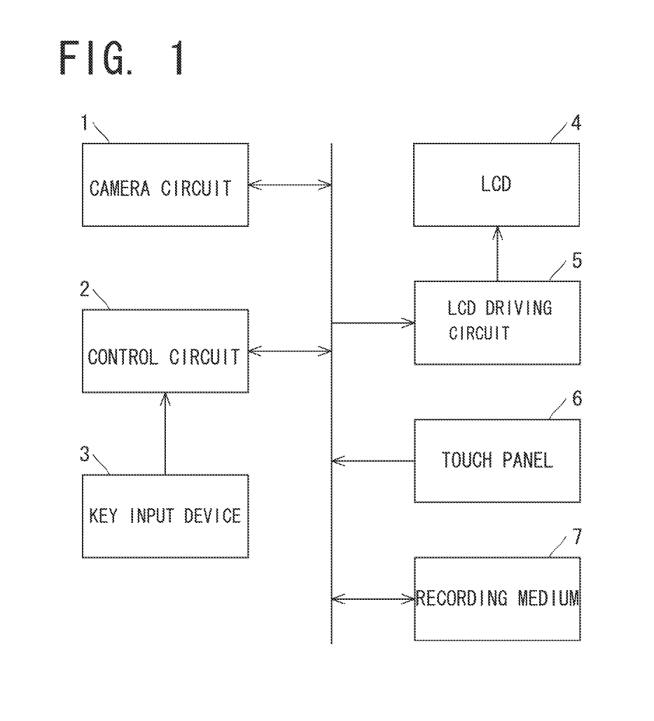

As shown in FIG. 1, the digital camera according to the embodiment of the present invention includes a camera circuit 1 having an image pickup device, a liquid crystal display device 4 for displaying a through-the-lens image obtained from the camera circuit 1 by photographing, an LCD driving circuit 5 for driving the liquid crystal display device 4, a touch panel 6 provided to cover a screen of the liquid crystal display device 4, a recording medium 7 for recording a still image or a moving image which is photographed, a key input device 3 such as a still image photographing button, and a control circuit 2 including a CPU and the like for controlling operations of the camera circuit 1, the LCD driving circuit 5, and the recording medium 7 in response to a manipulation of the key input device 3 or the touch panel 6.

The control circuit 2 has an automatic exposing function (an AE function) for automatically adjusting an exposure condition by setting, as a target, an automatic exposed area (an AE area) which is specified on a screen, an image recording function for recording a frame image in the recording medium 7 in response to a manipulation of the still image photographing button, and an area setting function for setting a plurality of AE areas on the screen in response to a manipulation of the touch panel 6. The AE function serves to adjust the exposure condition by setting, as a target, the plurality of AE areas set by the area setting function.

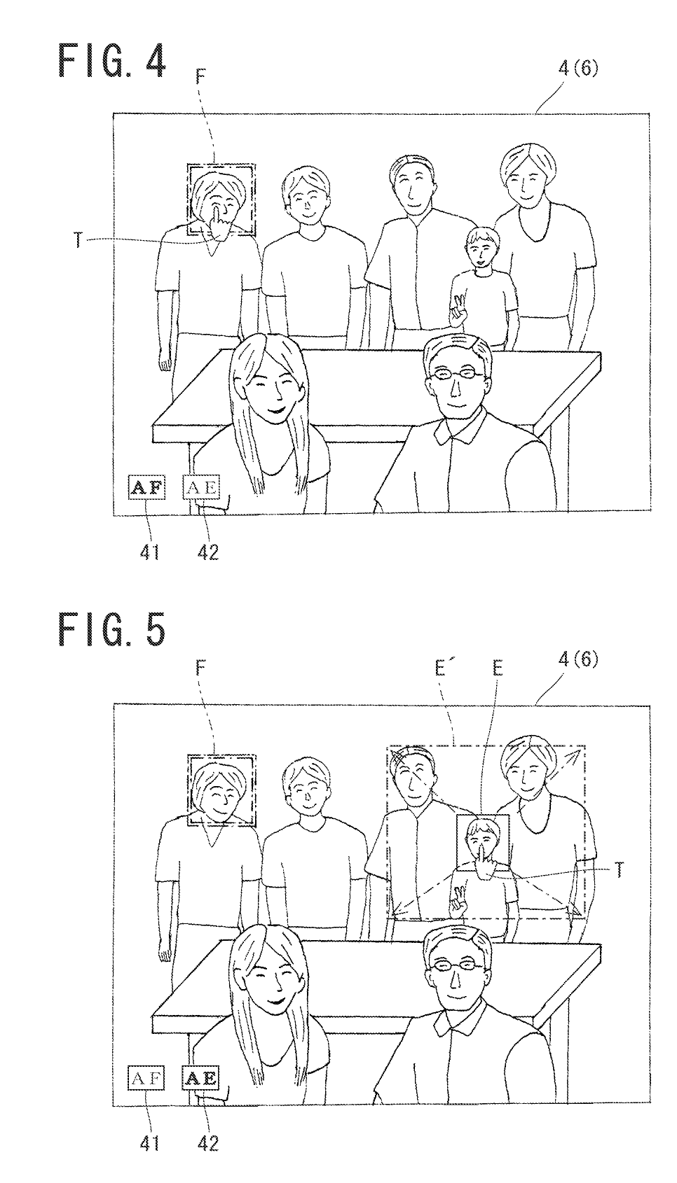

In the digital camera, as shown in FIG. 4, a photographing mode is set. When an AF (automatic focusing) button (41) displayed on the bottom left part of the screen is pressed in a state in which a through-the-lens image is displayed on a screen of the liquid crystal display device 4, an AF area changing mode is set. When a user touches any position T in this state, an AF area F is set at the touched position as indicated by a double dashed-dotted line in the figure.

By setting, as a target, an object image included in the AF area F, an automatic focusing operation (an AF operation) and an automatic exposing operation (an AE operation) are executed.

Thereafter, when an AE button (42) displayed on the bottom left part of the screen is pressed, switching from the AF area changing mode to the AE area changing mode is carried out as shown in FIG. 5.

When any position T on an outside of the AF area on the screen is touched in the AE area changing mode, an AE area E is set at the touched position. As long as the touching manipulation is continuously carried out, an AE area E′ is enlarged with a similar shape maintained as indicated by a dashed-dotted line.

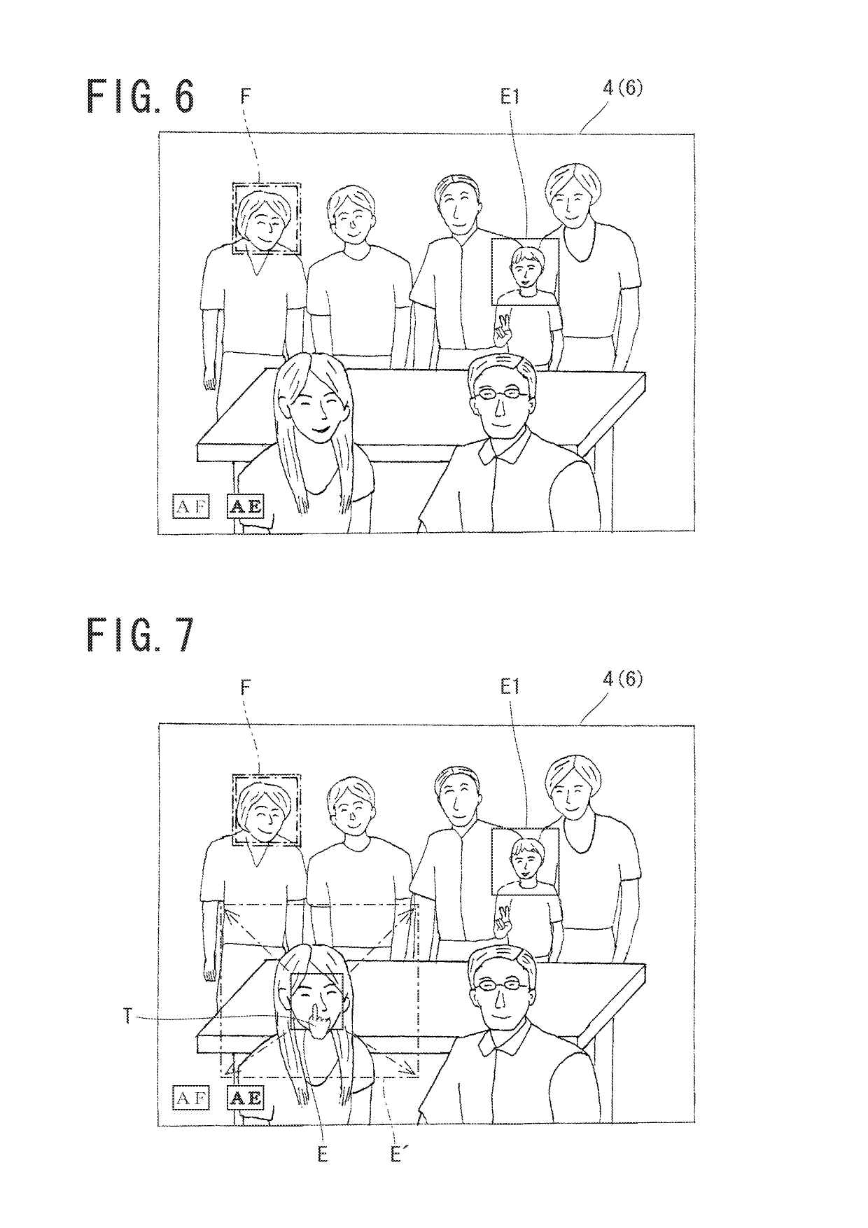

When the touching manipulation is ended on the way, the enlargement of the AE area is stopped at that time. Consequently, an AE area E1 is determined in a size obtained at that time as shown in FIG. 6.

When any position T on an outside of the determined AE area is touched in this state as shown in FIG. 7, an AE area E is set at the touched position in the same manner. As long as the touching manipulation is continuously carried out, an AE area E′ is enlarged with a similar shape maintained as indicated by a dashed-dotted line.

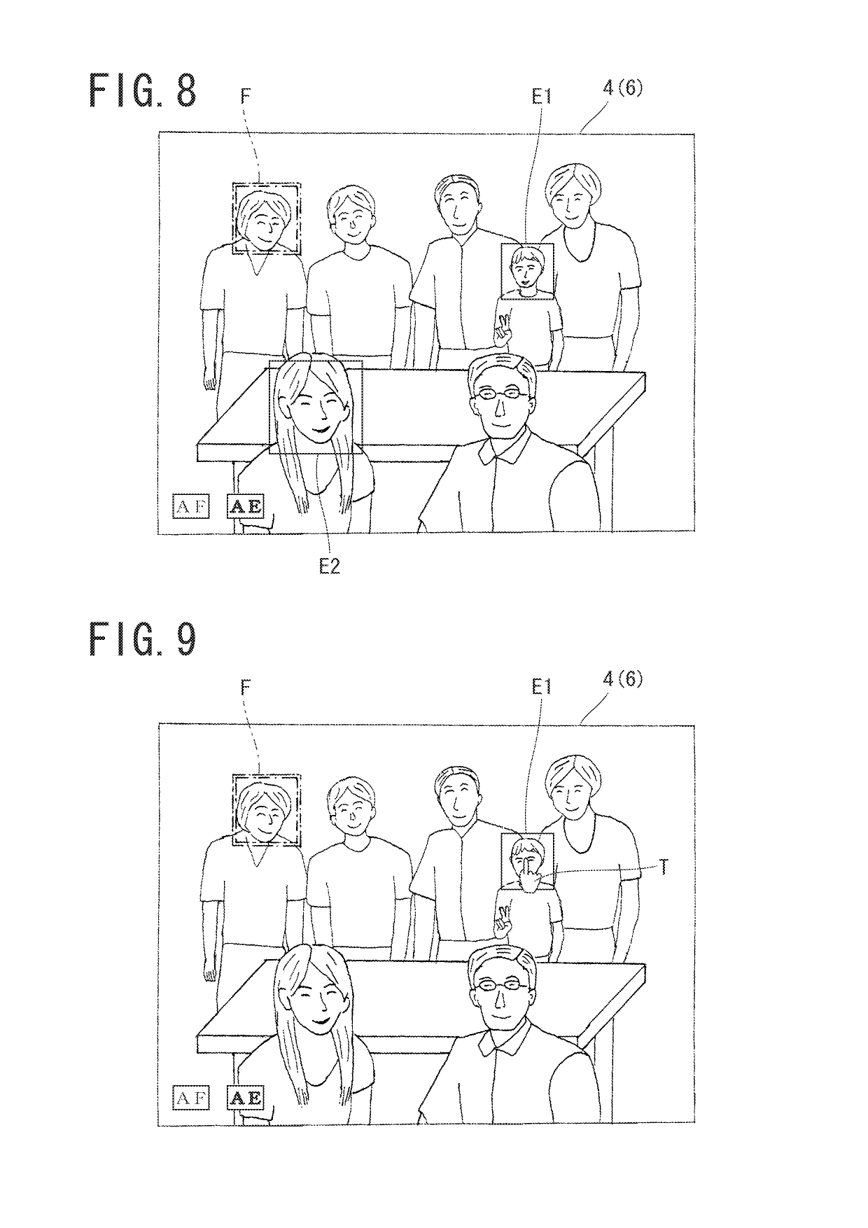

When the touching manipulation is ended on the way, the enlargement of the AE area is stopped at that time. Consequently, an AE area E2 is determined in a size obtained at that time as shown in FIG. 8.

Subsequently, by repeating the same touching manipulation, it is possible to specify a plurality of AE areas.

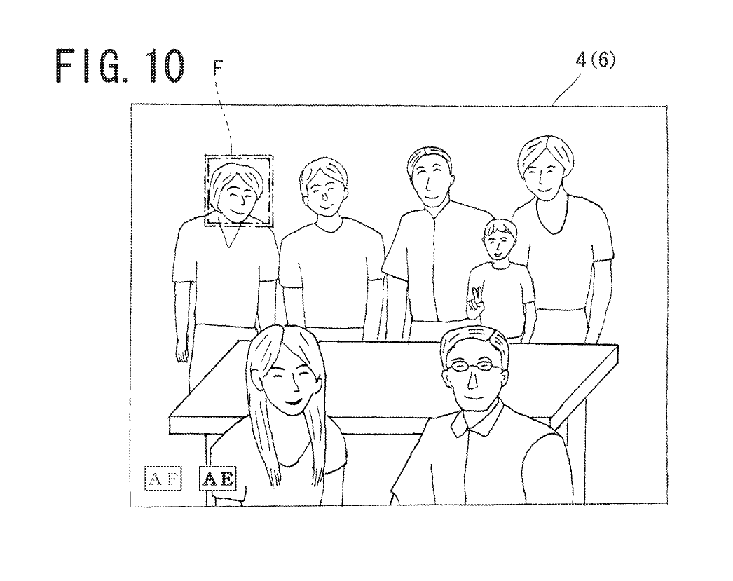

When a position T on an inside of the AE area E1 is touched as shown in FIG. 9 in a state in which the AE area E1 is specified as shown in FIG. 6, the specifying of the AE area E1 is canceled as shown in FIG. 10.

Thus, a user can set a plurality of AE areas having desirable sizes in desirable positions on the screen. When the still image photographing button is pressed in this state, an AE operation is executed by setting the plurality of AE areas as a target. The AF area set on the screen in the AF area changing mode as shown in FIG. 4 serves as the target of the AF operation, as well as the target of the AE operation.

After the execution of the AE operation, a still image is photographed (recorded in a recording medium).

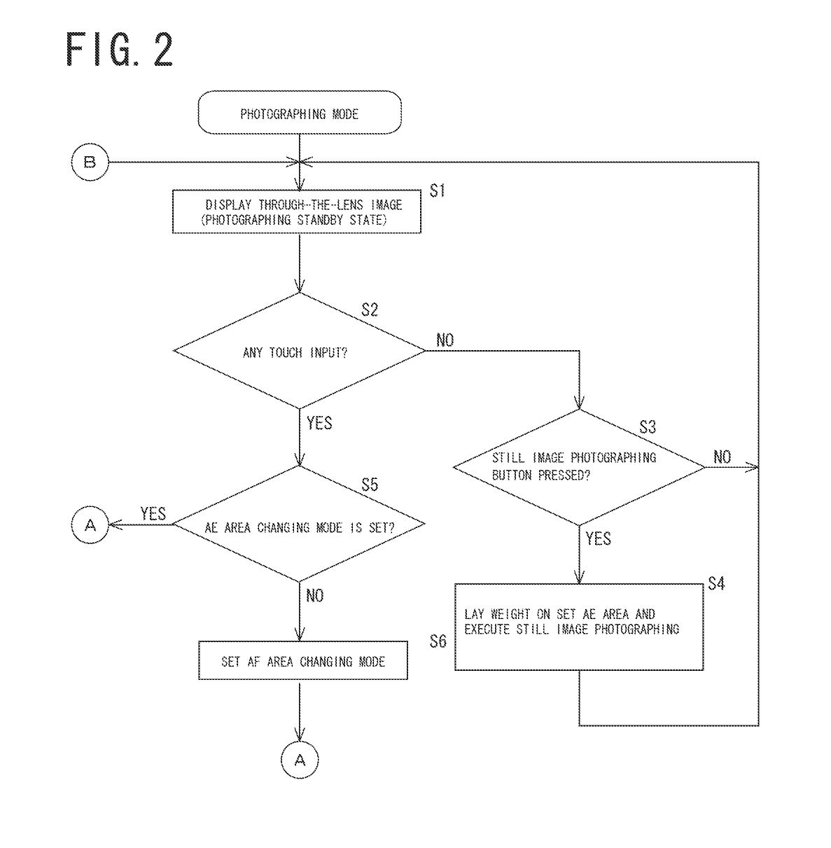

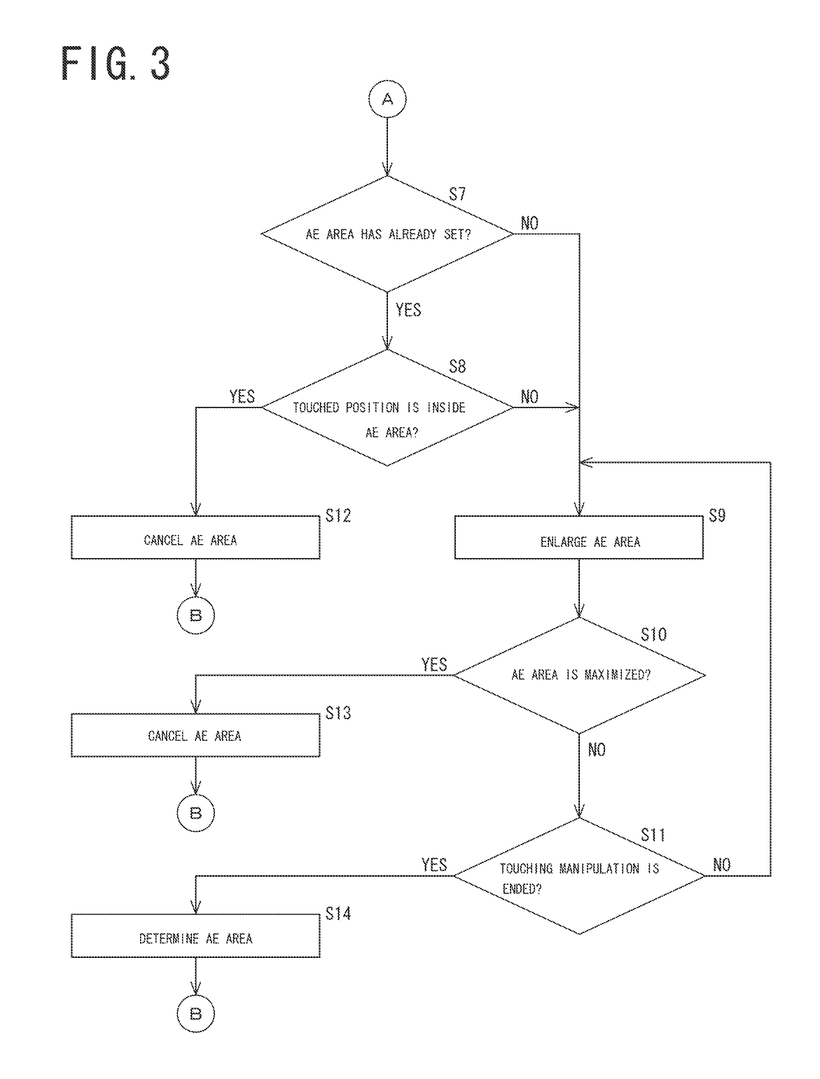

FIGS. 2 and 3 represent a control procedure of the control circuit 2 in a photographing mode.

First, in Step S1 of FIG. 2, a through-the-lens image is displayed on the screen of the liquid crystal display device, and a photographing standby state is set.

In Step S2, next, it is decided whether a touch input is carried out or not. If the decision is NO, the processing proceeds to Step S3 in which it is decided whether the still image photographing button is pressed or not. If the decision is NO, the processing returns to Step S1 in which a through-the-lens image is displayed continuously.

If the decision is YES in Step S2, the processing proceeds to Step S5 in which it is decided whether setting into an AE area changing mode is carried out or not. If the decision is YES, the processing proceeds to Step S7 in FIG. 3.

If the decision is NO in Step S5, the processing proceeds to Step S6 in which setting into an AF area changing mode is carried out. Then, the processing proceeds to Step S7 in FIG. 3.

In Step S7 in FIG. 3, it is decided whether the AE area has already been set or not. If the decision is NO, the processing proceeds to Step S9 in which an enlargement of the AE area is started around a touched position.

If the decision is YES in Step S7, it is decided whether the touched position is placed on an inside of the AE area or not.

If the decision is NO in Step S8, the processing proceeds to Step S9 in which the enlargement of the AE area is started around the touched position.

Then, it is decided whether the AE area is maximized or not in Step S10. If the decision is NO, the processing proceeds to Step S11 in which it is decided whether the touching manipulation is ended or not. If the decision is NO, the processing returns to Step S9 in which the enlargement of the AE area is continuously carried out.

Thereafter, if the decision is YES in Step S10, the processing proceeds to Step S13 in which the specifying of the AE area is cancelled. Then, the processing returns to Step S1 in FIG. 2.

If the decision is YES in Step S11 in FIG. 3, the processing proceeds to Step S14 in which the specifying of the AE area is determined. Thereafter, the processing returns to Step S1 in FIG. 2.

If the decision is YES in Step S8 in FIG. 3, the processing proceeds to Step S12 in which the specifying of the touched AE area is cancelled. Subsequently, the processing returns to Step S1 in FIG. 2.

If the decision is YES in Step S3 in FIG. 2 in a state in which a plurality of AE areas is thus specified, the processing proceeds to Step S4 in which a predetermined weight is laid on the plurality of AE areas which are set, and furthermore, an AE operation is executed by setting the AE areas as a target, and then a still image is photographed (recorded in a recording medium). Thereafter, the processing returns to Step S1.

According to the procedure, every time a user touches any position on the screen, the touching operation is detected in Step S2 and the AE area is set to the touched position via Steps S6 to S11 and S14.

Consequently, the plurality of AE areas is set on the identical screen and the still image photographing button is pressed in this state so that the press is detected in Step S3. In Step S4, the AE operation is executed by setting the plurality of AE areas as a target, and a still image is recorded.

When a single position on the screen is continuously touched, the AE area is enlarged gradually around the touched position in Step S9 in FIG. 3. Consequently, it is possible to set an AE area having a desirable size.

Accordingly, it is possible to automatically adjust an exposure condition to only objects which are displayed on the through-the-lens image and are specified by a user, thereby photographing a still image by setting the objects as a target.

Moreover, the predetermined weight is laid on the plurality of AE areas when the AE operation is to be executed by setting the plurality of AE areas as a target in Step S4 in FIG. 2. Therefore, it is possible to achieve an exposure condition of the user's desired balance for the plurality of object images by laying the greatest weight on the AE operation in the AF area set first and then laying, on the AE area, a weight which is gradually reduced in set order.

It should be noted that the configuration of each portion according to the present invention is not restricted to the embodiment described above, and those skilled in the art could make various modifications without departing from the spirit of the present invention described in the claims. For example, the AE operation for the plurality of AE areas may employ a method of executing it at one time upon a still image photographing manipulation, as well as a method of executing the AE operation by setting at least one AE area as a target which has already been set every time the AE area is sequentially set.

Furthermore, a display of a frame of the AF area and that of the AE area can also be distinguished through a change in a color, a blinking display and the like, in addition to a method of distinguishing both of them through a change in a line type.

What is claimed is:

1. An image producing apparatus comprising:
a display device which displays a frame image generated sequentially by photographing;
a touch panel provided to cover a screen of the display device;
an automatic exposing unit which automatically adjusts an exposure condition by setting, as a target, an automatic exposed area which is set on the screen;
an image recording unit which records the frame image in response to a user manipulation; and
an area setting unit which sets a plurality of automatic exposed areas on the screen in response to a manipulation of the touch panel,
wherein the automatic exposing unit adjusts the exposure condition by setting, as a target, the plurality of automatic exposed areas which are set by the area setting unit.

2. The image producing apparatus according to claim 1, wherein the automatic exposing unit lays a weight on the plurality of automatic exposed areas in a predetermined order when adjusting the exposure condition by using, as a target, the plurality of automatic exposed areas set by the area setting unit in response to a still image photographing manipulation.

3. The image producing apparatus according to claim 1, wherein the area setting unit sets an automatic exposed area at a touched position when any position on the screen is touched, and sets a next automatic exposed area at a touched position when the touching manipulation is ended and any position other than a region in which the automatic exposed area has already been set is then touched.

4. The image producing apparatus according to claim 1, wherein the area setting unit enlarges an automatic exposed area as long as any position on the screen is touched, and determines the automatic exposed area when the touching manipulation is ended.

5. The image producing apparatus according to claim 1, wherein the area setting unit cancels a specifying of a single automatic exposed area when an inside of the automatic exposed area is touched in a state in which at least one automatic exposed area is set on the screen.

6. A method of producing an image using the image producing apparatus as defined in claim 1, the method comprising setting a plurality of automatic exposed areas on the screen in response to a manipulation of the touch panel, and adjusting the exposure condition by setting, as a target, the plurality of automatic exposed areas which are set.
